(19) United States
(12) Patent Application Publication
(10) Pub. No.: US 2011/0048769 A1
(43) Pub. Date: Mar. 3, 2011

(54) INSULATING FILM, METHOD OF MANUFACTURING THE SAME, AND SEMICONDUCTOR DEVICE

(75) Inventor: Naonori FUJIWARA, Chuo-ku (JP)

(73) Assignee: ELPIDA MEMORY, INC., Tokyo (JP)

(21) Appl. No.: 12/871,400

(22) Filed: Aug. 30, 2010

(30) Foreign Application Priority Data
Sep. 1, 2009 (JP) 2009-201448

(51) Int. Cl. H01B 3/00

(52) U.S. Cl. 174/137 B

(57) ABSTRACT

An exemplary aspect of the invention provides an insulating film which has a high dielectric constant and has small leakage current even when it is sandwiched between electrodes. The insulating film comprises two zirconium oxide layers in crystallized state; and an intergranular isolating layer composed of an amorphous material having a dielectric constant higher than that of zirconium oxide in crystallized state; wherein the intergranular isolating layer is sandwiched between the two zirconium oxide layers. The insulating film is properly used as a capacitive insulating film in a semiconductor device comprising a memory cell including a capacitor element having the capacitive insulating film between an upper electrode and a lower electrode, or as an intergate insulating film in a semiconductor device comprising a nonvolatile memory device having the intergate insulating film between a control gate electrode and a floating gate electrode.

This application is based upon and claims the benefit of priority from Japanese patent application no. 2009-201448, filed on Sep. 1, 2009, the disclosure of which is incorporated herein in its entirety by reference.

### BACKGROUND OF THE INVENTION

1. Field of the Invention

An exemplary aspect of the invention relates to an insulating film, a method of manufacturing the same, a semiconductor device, and a data processing system.

2. Description of the Related Art

With high integration of the semiconductor device, demand for an insulating film (a dielectric film) with a high dielectric constant and low leakage current is increasing. For example, capacitor-mounted devices such as DRAM devices require an insulating film with a high dielectric constant and low leakage current as means that do not reduce as much electrostatic capacitance as possible even when the size of a memory cell becomes smaller owing to miniaturization.

Insulating films that satisfy the demand include a zirconium oxide (ZrO₂) film. Since the zirconium oxide has a band gap energy that is greater than that of a titanium oxide, it has an advantage for forming an insulating film with low leakage current. Further, a method of stacking an insulating film composed of two or more kinds of materials including the zirconium oxide has also been proposed in order to reduce the leakage current furthermore (JP 2007-73926 A and JP 2002-222934 A).

### SUMMARY OF THE INVENTION

It has been known that an amorphous zirconium oxide has specific dielectric constant of approximately 25 while a crystallized zirconium oxide has an increased dielectric constant. The crystallized zirconium oxide has a specific dielectric constant of approximately 35 in cubic structure and of to approximately 45 in tetragonal structure. However, the crystallized zirconium oxide had a problem of increase of leakage current as compared to the amorphous zirconium oxide. This is assumed because an electric current flowing through grain boundaries increases.

Thus, according to the related art, as disclosed in JP 2007-73926 A, an uncrystallized zirconium oxide was used to restrict a leakage current below a certain value. However, in case of the insulating film using the uncrystallized zirconium oxide, if the film thickness is made too much smaller, the leakage current exceeds a certain level, so that there exists a limitation in making the insulating film thinner. Thus, it is impossible to further increase the electrostatic capacitance of the insulating film sandwiched between electrodes. That is, it is difficult to form an element such as a capacitor, having a reduced occupied area that is provided corresponding to the miniaturization thereof, using an uncrystallized zirconium oxide, because the uncrystallized zirconium oxide has a small dielectric constant.

An exemplary aspect of the invention provides an insulating film comprising:

two zirconium oxide layers in crystallized state; and

an intergranular isolating layer composed of an amorphous material having a dielectric constant higher than that of zirconium oxide in crystallized state;

wherein the intergranular isolating layer is sandwiched between the two zirconium oxide layers.

An exemplary aspect of the invention provides an insulating film comprising:

three zirconium oxide layers in crystallized state; and

two intergranular isolating layers composed of an amorphous material having a dielectric constant higher than that of zirconium oxide in crystallized state;

wherein each of the intergranular isolating layers is sandwiched between two of the three zirconium oxide layers.

An exemplary aspect of the invention provides a method of manufacturing an insulating film, comprising:

forming a first zirconium oxide layer in amorphous state;

forming an intergranular isolating layer in amorphous state on the first zirconium oxide layer;

forming a second zirconium oxide layer in amorphous state on the intergranular isolating layer; and

annealing a stack of layers including the first and the second zirconium oxide layers and the intergranular isolating layer to crystallize zirconium oxide in amorphous state in the first and second zirconium oxide layers,

wherein after the annealing has been performed, the intergranular isolating layer is in amorphous state, and the intergranular isolating layer has a dielectric constant higher than that of zirconium oxide in crystallized state in the first and the second zirconium oxide layers.

An exemplary aspect of the invention provides a semiconductor device comprising a memory cell including a capacitor element having a capacitive insulating film between an upper electrode and a lower electrode,

the capacitive insulating film comprising:

two zirconium oxide layers in crystallized state; and

an intergranular isolating layer composed of an amorphous material having a dielectric constant higher than that of zirconium oxide in crystallized state;

wherein the intergranular isolating layer is sandwiched between the two zirconium oxide layers.

An exemplary aspect of the invention provides a semiconductor device comprising a nonvolatile memory device having an intergate insulating film between a control gate electrode and a floating gate electrode,

the intergate insulating film comprising:

two zirconium oxide layers in crystallized state; and

an intergranular isolating layer composed of an amorphous material having a dielectric constant higher than that of zirconium oxide in crystallized state;

wherein the intergranular isolating layer is sandwiched between the two zirconium oxide layers.

An exemplary aspect of the invention provides a data processing system comprising an arithmetic processing device and a DRAM device, which are interconnected to the data processing system via a system bus,

the DRAM device comprising a memory cell including a capacitor element having a capacitive insulating film between an upper electrode and a lower electrode,

the capacitive insulating film comprising:

two zirconium oxide layers in crystallized state; and

an intergranular isolating layer composed of an amorphous material having a dielectric constant higher than that of zirconium oxide in crystallized state;

wherein the intergranular isolating layer is sandwiched between the two zirconium oxide layers.

An exemplary aspect of the invention can provide an insulating film which has a high dielectric constant and has small leakage current when it is sandwiched between electrodes. When a memory cell of a DRAM device is configured using the capacitor element in which an insulating film of an exemplary aspect of the invention is sandwiched between electrodes, the DRAM device can be easily formed which has an excellent data retention characteristic even when the DRAM device is made smaller and the size of the memory cell is reduced. Moreover, a nonvolatile memory device having an excellent leakage characteristic can be easily formed using an insulating film of an exemplary aspect of the invention.

### BRIEF DESCRIPTION OF THE DRAWINGS

FIG. 1 is a schematic cross-sectional view showing a structure of a capacitor element having an insulating film according to a first embodiment.

FIG. 2 is a flow chart showing a procedure of a method of forming a capacitor element having an insulating film according to a first embodiment.

FIG. 3 is a flow chart showing a procedure of a method of forming a zirconium oxide film using an ALD method.

FIG. 4 is a flow chart showing a procedure of a method of forming a TiAlO film using an ALD method.

FIG. 5 is a graphical diagram showing correlation between composition ratio of aluminum oxide in the TiAlO film and a dielectric constant thereof.

FIG. 6 is a graphical diagram showing correlation between electrostatic capacitance and leakage current of the capacitor element.

FIG. 7 is a schematic cross-sectional view showing a structure of a capacitor element having an insulating film according to a modified embodiment of a first embodiment.

FIG. 8 is a schematic diagram showing a planar layout of a memory cell part of a DRAM device according to a second embodiment.

FIG. 9 is a schematic cross-sectional view taken along line A-A′ shown in FIG. 8.

FIG. 10 is a partial cross-sectional view for explaining a method of forming a capacitor element.

FIG. 11 is a partial cross-sectional view for explaining a method of forming a capacitor element.

FIG. 12 is a partial cross-sectional view for explaining a method of forming a capacitor element.

FIG. 13 is a schematic cross-sectional view showing a nonvolatile memory device according to a third embodiment.

FIG. 14 is a schematic diagram showing a construction of a data processing system according to a third embodiment.

### DETAILED DESCRIPTION OF THE PREFERRED EMBODIMENTS

### First Embodiment

FIG. 1 is a schematic cross-sectional view showing a structure of a capacitor element having an insulating film according to a first embodiment.

The capacitor element is formed such that a multi-layered insulating film 10 is sandwiched between a lower electrode 1 and an upper electrode 2 that are composed of a conductive material such as a titanium nitride (TiN). The insulating film 10 is configured by forming an intergranular isolating layer 4 on a crystallized zirconium oxide (ZrO₂) layer 3 and by further forming thereon a crystallized zirconium oxide layer 5. The thicknesses of zirconium oxide layers 3 and 5 may be equal to or different from each other.

The intergranular isolating layer 4 is an insulating layer that has a specific dielectric constant higher than that of a crystallized zirconium oxide layer, and has a function of separating grain boundaries of the zirconium oxide, thereby restricting leakage current from flowing between the lower electrode 1 and the upper electrode 2. Specifically, an amorphous metal oxide layer containing aluminum (Al) and titanium (Ti) can be used as the intergranular isolating layer 4.

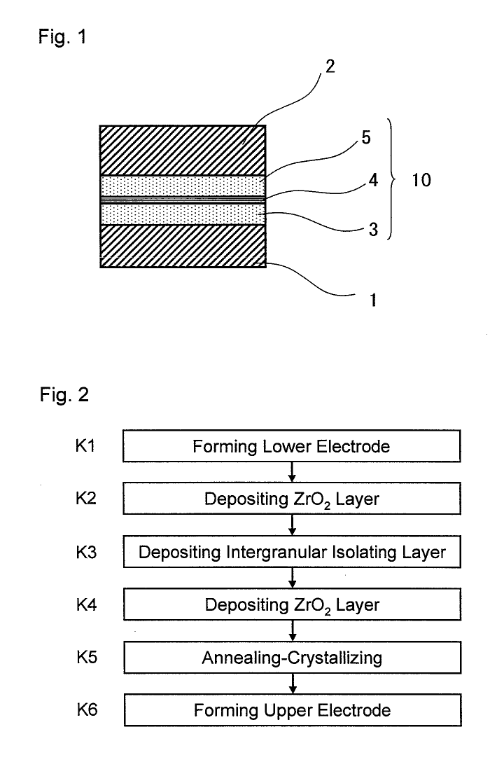

A capacitor element having an insulating film according to an exemplary embodiment is formed for example by processes K1 to K6 shown in the flow chart of FIG. 2. Meanwhile, the details of the method of depositing insulating film 10 will be described later.

Process K1:

A lower electrode 1 is patterned on a semiconductor substrate (not shown) using a conductive material such as titanium nitride. The patterning is performed for example using photolithography. The conductive material for forming the lower electrode 1 is not limited to titanium nitride, and may be ruthenium (Ru), platinum (Pt), iridium (Ir), tungsten (W), and nitride thereof. Although a metal is preferably used as the conductive material for forming the lower electrode 1, poly-crystal silicon doped with impurities such as phosphorus may also be used.

Process K2:

A semiconductor substrate in which a lower electrode 1 has been formed is provided in a reaction chamber of an ALD (Atomic Layer to Deposition) film-forming apparatus. Then, zirconium oxide is deposited on the lower electrode 1 in a thickness of approximately 3 to 5 nm using an ALD method, thereby forming a zirconium oxide layer 3. The zirconium oxide deposited in this process has an amorphous phase.

Process K3:

A material for forming an intergranular isolating layer is deposited in a thickness of approximately 0.5 to 0.8 nm on a zirconium oxide layer 3 using an ALD method, thereby forming an intergranular isolating layer 4. The material for forming the intergranular isolating layer is selected from materials which can be deposited in an amorphous phase and can maintain the amorphous phase even after processed with following annealing-crystallizing process (K5). In addition, the material for forming the intergranular isolating layer is selected from materials which have a dielectric constant higher than that of a crystallized zirconium oxide. For example, the intergranular isolating layer 4 may be a metal oxide layer (TiAlO layer) containing aluminum and titanium.

Process K4:

A zirconium oxide is deposited on an intergranular isolating layer 4 in a thickness of approximately 3 to 5 nm using an ALD method, thereby forming a zirconium oxide layer 5. The zirconium oxide deposited in this process has an amorphous phase.

Process K5:

Heat treatment (annealing) for 10 minutes is performed under nitrogen atmosphere at approximately 500 to 600° C. to crystallize zirconium oxide in zirconium oxide layers 3 and 5. The heat treatment may also be performed under oxygen (O₂)-contained atmosphere. When the annealing to is performed under oxygen-contained atmosphere, an oxidation-resistant metal material (for example, platinum) is preferably used as a conductive material for forming a lower electrode 1. A material for an intergranular isolating layer 4 is configured such that it is not crystallized in this annealing process (a configuration will be made later to the case where a TiAlO layer is used as the intergranular isolating layer). In the mean time, in terms of raising a dielectric constant, crystallization is preferably performed under a controlled temperature and time for annealing in order to allow zirconium oxide to be crystallized into a tetragonal structure.

Process K6:

An upper electrode 2 is patterned on a zirconium oxide layer 5 using a conductive material such as a titanium nitride. An upper electrode 2 and a lower electrode 1 may be formed using the same or a different conductive material. In addition, the upper electrode 2 and the lower electrode 1 each may consist of a single layer or a multi-layered stack of different kinds of materials.

In the above-mentioned manufacturing process, it is possible to reverse the order of processes K5 and K6 from each other and to perform annealing-crystallizing process after forming an upper electrode 2.

In addition, if heat of 500° C. or more is applied when an upper electrode 2 is formed, a portion or the whole of annealing-crystallizing process K5 may be the process of forming an upper electrode 2. That is, according to an exemplary embodiment, annealing-crystallizing process K5 may be not essentially performed solely. In the case where the zirconium oxide of zirconium oxide layers 3 and 5 is finally crystallized with heat applied after an zirconium oxide layer 5 has been formed, individual annealing-crystallizing process K5 may not be needed.

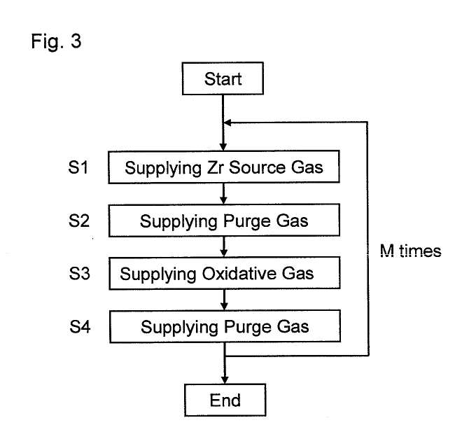

In the followings, a method of forming a zirconium oxide layer using an ALD method will be described in detail with reference to the process flow chart of FIG. 3. The zirconium oxide layers formed in processes K2 and K4 can be formed similarly with the following method.

Process S1:

The temperature of a reaction chamber of an ALD film-forming apparatus is set to approximately 200 to 250° C., and TEMAZ (tetrakis(ethylmethylamino)zirconium) gas as a zirconium source gas is supplied into the reaction chamber for approximately 10 seconds. The zirconium source gas may be supplied while being diluted with an inert gas such as Ar. If a lower electrode 1 has a complex 3-dimensional structure or a high aspect ratio, the supplying time of the zirconium source gas may extend to approximately 180 seconds. The supplied zirconium source gas is chemically adsorbed onto a surface of a lower electrode 1 so as to form a thin layer with roughly a zirconium atomic monolayer on the lower electrode 1.

Process S2:

Nitrogen (N₂) or Ar gas as a purge gas is supplied into the reaction chamber so as to discharge the zirconium source gas that remains without being adsorbed during the process S1 from the reaction chamber.

Process S3:

Ozone (O₃) as an oxidative gas is supplied into the reaction chamber for approximately 10 seconds while the temperature of the reaction chamber is kept to be approximately 200 to 250° C. The zirconium that is adsorbed onto the surface of the electrode during the process S1 is oxidized so as to form zirconium oxide (ZrO₂). However, in this process, zirconium oxide is not completely crystallized and is in an amorphous phase. In the context of removing remaining impurities contained in zirconium oxide using sufficient oxidation, the supplying time of ozone may extend to approximately 180 seconds.

Further, an oxidative gas except for ozone may also be used. Specifically, oxygen gas (O₂), water vapor (H₂O), ozone diluted with an inert gas such as Ar or the like may can be used.

Process S4:

Nitrogen or Ar gas as a purge gas is supplied into the reaction chamber so as to discharge the oxidative gas that remains without being associated in the oxidation during the process S3 from the reaction chamber.

Then, the processes S1 to S4 are combined in a single cycle and the cycle is repeated M times (M is an integer of 1 or more), so that the zirconium oxide layer having a desired thickness may be formed. For example, the zirconium oxide layer of approximately 3 to 5 nm may be formed by repeating the cycle of processes S1 to S4 approximately 20 to 40 times.

Next, an intergranular isolating layer 4 will be described in detail.

An intergranular isolating layer maintains an amorphous phase when a semiconductor device has been manufactured, so that it can separate grain boundaries of the crystallized zirconium oxide. That is, the intergranular isolating layer serves as a stopper layer for leakage current and has a high band gap, so that it is used in an insulating film that is able to restrict leakage current from flowing.

The thickness of the intergranular isolating layer 4 is preferably about 0.5 nm or more. That is, the intergranular isolating layer is thickened to a certain level and has an effect on separating grain boundaries of the crystallized zirconium oxide, thereby sufficiently restricting leakage current. It is preferred that the thickness of the intergranular isolating layer 4 be approximately 1.0 nm or less in the context of an effective oxide thickness.

Meanwhile, although an amorphous aluminum oxide (Al₂O₃) layer has a sufficient insulating function, it only has a low specific dielectric constant of approximately 9. Further, if the amorphous aluminum oxide layer is used while being combined with a zirconium oxide crystal layer (having a specific dielectric constant of 35 to 45) as an intergranular isolating layer, a dielectric constant of the whole multi-layered insulating layer becomes more reduced. Therefore, as a result of studying material of an insulating layer that has a dielectric constant higher than that of the crystallized zirconium oxide and also has a function of separating grain boundaries, it has been found that a TiAlO layer composed of a metal oxide containing aluminum and titanium is suitable for an intergranular isolating layer.

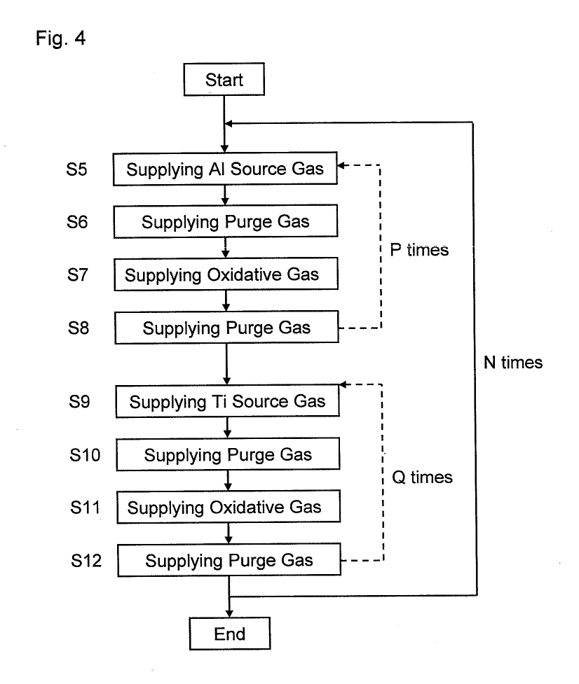

A method of forming a TiAlO layer using an ALD method will now be described with reference to the process flow chart of FIG. 4.

Process S5:

The temperature of a reaction chamber of an ALD film-forming apparatus is set to approximately 200 to 250° C., and TMA (trimethylaluminum) gas as an aluminum source gas is supplied into the reaction chamber for about 10 seconds. The aluminum source gas may be supplied while being diluted with an inert gas such as Ar. If a lower electrode 1 has a complex 3-dimensional structure or a high aspect ratio, the supplying time of the aluminum source gas may extend to approximately 180 seconds. The supplied aluminum source gas is chemically adsorbed onto a surface of an underlayer so as to form a thin layer with roughly an aluminum atomic monolayer.

Process S6:

Nitrogen or Ar gas as a purge gas is supplied into the reaction chamber so as to discharge the aluminum source gas that remains without being adsorbed during the process S5 from the reaction chamber.

Process S7:

Ozone (O₃) as an oxidative gas is supplied into the reaction chamber for approximately 10 seconds while the temperature of the reaction chamber is kept to be approximately 200 to 250° C. The aluminum that is adsorbed onto the surface during the process S5 is oxidized so as to form aluminum oxide (Al₂O₃) that has a level of an atomic monolayer and is in an amorphous phase. In the context of removing remaining impurities contained in aluminum oxide using sufficient oxidation, the supplying time of ozone may extend to approximately 180 seconds.

Process S8:

Nitrogen or Ar gas as a purge gas is supplied into the reaction chamber so as to discharge the oxidative gas that remains without being associated in the oxidation during the process S7 from the reaction chamber.

Process S9:

TDMAT (tetrakis(dimethylamino)titanium) as a titanium source gas is supplied into the reaction chamber for about 10 seconds while the temperature of the reaction chamber is kept to be approximately 200 to 250° C. The titanium source gas may be supplied while being diluted with an inert gas such as Ar. If a lower electrode 1 has a complex 3-dimensional structure or a high aspect ratio, the supplying time of the titanium source gas may extend to approximately 180 seconds. The supplied titanium source gas is chemically adsorbed onto a surface of an underlayer so as to form a thin layer with roughly a titanium atomic monolayer.

Process S10:

Nitrogen or Ar gas as a purge gas is supplied into the reaction chamber so as to discharge the titanium source gas that remains without being adsorbed during the process S9 from the reaction chamber.

Process S11:

Ozone (O₃) as an oxidative gas is supplied into the reaction chamber for approximately 10 seconds while the temperature of the reaction chamber is kept to be approximately 200 to 250° C. The titanium that is adsorbed onto the surface during the process S9 is oxidized so as to form titanium oxide (TiO₂) that has a level of an atomic layer and is in an amorphous phase. In the context of removing remaining impurities contained in titanium oxide using sufficient oxidation, the supplying time of ozone may extend to approximately 180 seconds.

Process S12:

Nitrogen or Ar gas as a purge gas is supplied into the reaction chamber so as to discharge the oxidative gas that remains without being associated in the oxidation during the process S11 from the reaction chamber.

Then, the processes S5 to S12 are combined in a single cycle and the cycle is repeated N times (N is an integer of 1 or more), so that a TiAlO layer having a desired thickness may be formed. The resultant TiAlO layer can be considered in totality as a single insulating film, which does not have a stacked structure in which an aluminum oxide layer and a titanium oxide layer are completely individually separated from each other, but has the structure that is close to a mixed state. In one cycle of processes S5 to S12, the sub-cycle of processes S5 to S8 of depositing aluminum oxide may be repeated P times (P is an integer of 1 or more). Similarly, the sub-cycle of processes S9 to S12 of depositing titanium oxide may be repeated Q times (Q is an integer of 1 or more). In case where the sub-cycle of processes S5 to S8 and/or the sub-cycle of processes S9 to S12 are/is performed two or more times, it is preferred that the number of sub-cycle to be performed be controlled such that the thickness of at least one of aluminum oxide and titanium oxide, which are formed by the sub-cycles of the processes, is not more than approximately 0.1 nm. This is because, if the thicknesses of aluminum oxide and titanium oxide become thickened excessively by the performance of the sub-cycles, the resultant TiAlO layer becomes the stacked structure in which aluminum oxide and titanium oxide are individually separated from each other, so that the TiAlO layer cannot be preferably used as an intergranular isolating layer.

Meanwhile, in the processes S7 and S11, an oxidative gas except for ozone may be used. Specifically, oxygen gas (O₂), water vapor (H₂O), ozone diluted with an inert gas such as Ar, or the like may be used.

In the resultant TiAlO layer, the number (P and Q in FIG. 4) of the sub-cycles of the processes S5 to S8 and S9 to S12 to be performed is controlled, so that a composition ratio (content) of aluminum oxide component in the resultant TiAlO layer can be regulated.

As a result of examining the characteristics when changing the composition ratio of aluminum oxide component in the TiAlO layer, it has been proved that when the content of aluminum oxide component in the TiAlO layer is below 5 atomic %, the TiAlO layer may also be crystallized during heat treatment (annealing) process for crystallizing zirconium oxide. Thus, in order to maintain a function of separating grain boundaries, it is preferred that a TiAlO layer be formed such that the content of aluminum oxide component in the TiAlO layer is 5 atomic % or more.

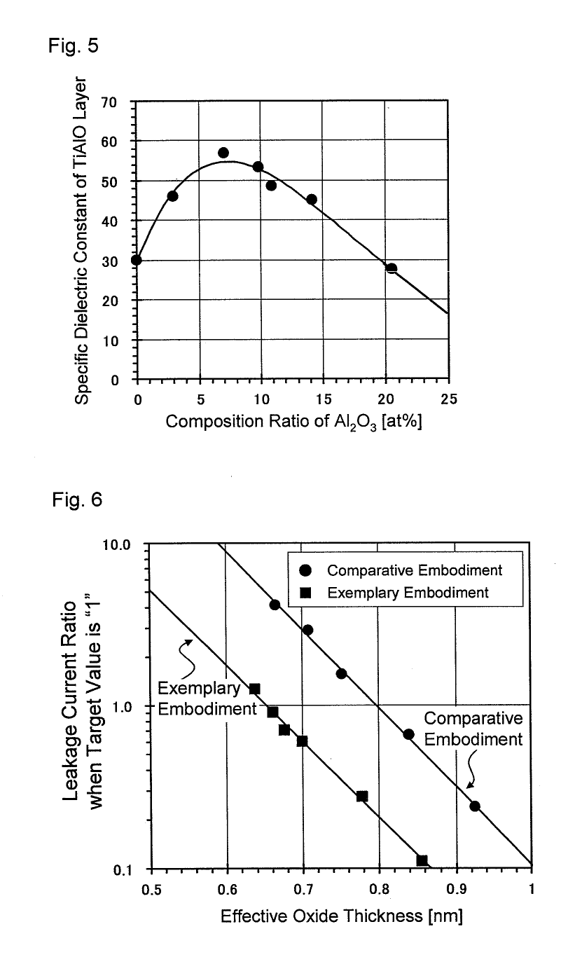

Next, the results of measuring dielectric constants of samples that the composition ratios of aluminum oxide component in the TiAlO layer are changed are shown in FIG. 5. Referring to FIG. 5, it can be seen that when the content of aluminum oxide component in the TiAlO layer is set to approximately 5 to 10 atomic %, an insulating film having a specific dielectric constant of 50 or more is stably obtained, and when the content of aluminum oxide component is approximately 15 atomic %, the insulating film having a specific dielectric constant similar to that of zirconium oxide crystallized in a tetragonal structure is obtained. In case where the insulating film is used as a capacitive insulating film for a capacitor in combination with zirconium oxide, it is preferred that an intergranular isolating layer having a dielectric constant similar to or higher than that of zirconium oxide be used in order to not to reduce electrostatic capacitance of a capacitor.

Thus, when the TiAlO layer is used as an intergranular isolating layer, the content of aluminum oxide component in a TiAlO layer is preferably set to approximately 5 to 15 atomic % and, more preferably, approximately 5 to 10 atomic %.

FIG. 6 shows the results of measuring electrostatic capacitances and leakage currents of a capacitor element using an insulating film manufactured with a method according to an exemplary embodiment. The horizontal axis of the graph shown in FIG. 6 indicates an electrostatic capacitance as an effective oxide thickness (EOT). The vertical axis indicates values of a leakage current standardized from that measured in order to be adapted to a DRAM device of a 40 to 45 nm-generation design rule. A plurality of samples were prepared, wherein the content of aluminum oxide component in a TiAlO layer was fixed to 10 atomic % and the thickness of the TiAlO layer was changed so that the effective oxide thickness was different. Further, as a comparative embodiment, measuring results performed on a capacitor formed using an insulating film, in which a monolayer of aluminum oxide is sandwiched between crystallized zirconium oxide layers, are shown in FIG. 6.

In case where the capacitor is adapted to a memory cell of a DRAM device of a 40 to 45 nm-generation design rule, it is needed the electrostatic capacitance that corresponds to approximately 0.7 to 0.8 nm of the effective oxide thickness. In an exemplary embodiment, it can be known that a capacitor can be formed, that has a characteristic maintaining leakage current below target leakage current (1.0 in the vertical axis) in the region where the effective oxide thickness exceeds 0.65 nm. Meanwhile, according to a comparative embodiment, in order to have a characteristic maintaining leakage current below target leakage current (1.0 in the vertical axis), it is needed to set the effective oxide thickness to 0.8 nm or more. Thus, it can be seen that when adapting to a memory cell of a DRAM device of a 40 to 45 nm-generation design rule, the electrostatic capacitance is not enough. This is because, in case where a monolayered aluminum oxide layer is used as a separating layer against a zirconium oxide layer, while the aluminum oxide layer maintains an amorphous phase and thus has a function of restricting leakage current, the specific dielectric constant only amounts to approximately 9 and thus the dielectric constant of the whole insulating film is greatly reduced. In addition, in case of an aluminum oxide monolayer, if the layer is made thinner up to approximately 0.3 nm, reduction in electrostatic capacitance can be restricted, but a separating effect of grain boundaries is also reduced, so that leakage current becomes increased.

As set forth before, according to an exemplary embodiment, an insulating layer that maintains an amorphous phase and has a specific dielectric constant higher than that of crystallized zirconium oxide is used as an intergranular isolating layer, so that it is possible to restrict leakage current without reduction in electrostatic capacitance. According to an exemplary embodiment, it is possible to form an insulating layer having an EOT of from 0.65 to 0.8 nm.

Meanwhile, a source gas used in an ALD method is not limited to that described, but another source gas can be used in order to form a zirconium oxide layer or a TiAlO layer. Further, an intergranular isolating layer is not limited to a TiAlO layer, but a metal oxide layer containing another metal element (for example, Hf, La, Ta, Y, and the like) in addition to titanium (Ti) and aluminum (Al) can be used. However, a ratio of added metal is controlled in order to keep an intergranular isolating layer in an amorphous phase throughout the manufacturing process of the semiconductor device.

### Modified Embodiment of First Embodiment

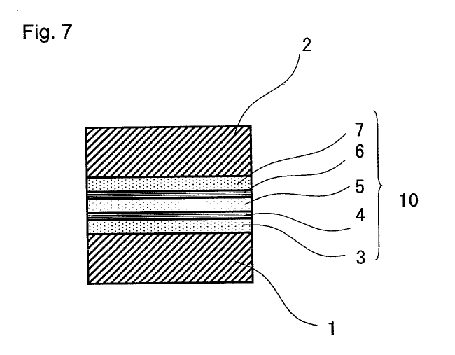

FIG. 7 is a schematic cross-sectional view showing a structure of a capacitor element having an insulating film according to an exemplary embodiment. An insulating film of an exemplary embodiment may be provided with two or more intergranular isolating layers.

In FIG. 7, a multi-layered insulating film 10 is arranged between a lower electrode 1 and an upper electrode 2 so as to form a capacitor. The insulating film 10 is configured such that two intergranular isolating layers 4 and 6 are sandwiched among three crystallized zirconium oxide layers 3, 5 and 7.

The insulating film 10 can be formed by sequentially depositing respective layers constituting the insulating film using an ALD method. The intergranular isolating layer may be a TiAlO layer. In this case, it is preferable to set a content of aluminum oxide component in each of the TiAlO layers in a range of from 5 to 15 atomic %. Meanwhile, when the intergranular isolating layer consists of two or more layers, the respective intergranular isolating layers may have the same or a different composition material. The respective zirconium oxide layers may have the same or a different thickness. Similarly, the respective intergranular isolating layers may have the same or a different thickness.

### Second Embodiment

In the followings, it will be described a case where an exemplary embodiment is applied to a capacitive insulating film of a capacitor element constituting a memory cell of a DRAM device, which is a specific example to which an insulating film of an exemplary embodiment is applied.

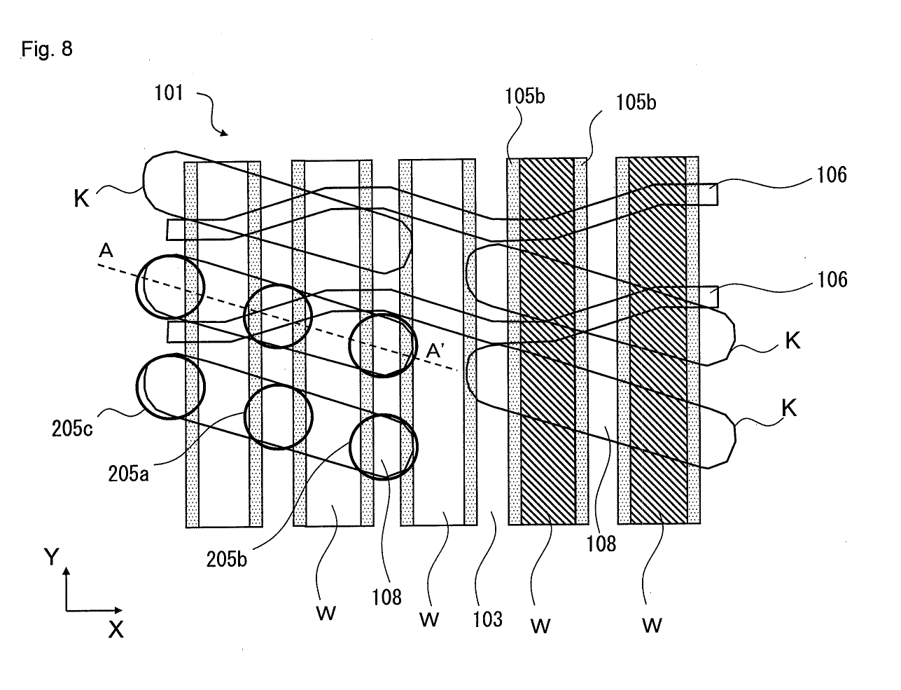

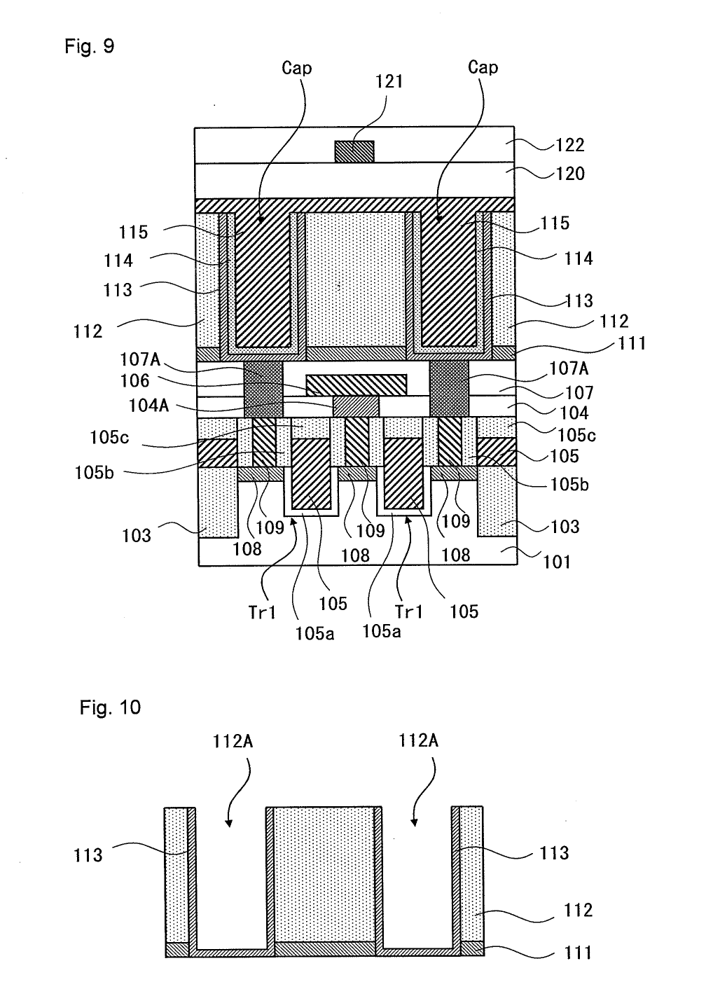

FIG. 8 is a schematic diagram showing a planar layout of a memory cell part of a DRAM device to which an insulating film of an exemplary embodiment is applied. The right side of FIG. 8 is shown as a perspective sectional view based on a surface that cuts a gate electrode 105 and a side wall 105b that will be a word wiring (W), as described below. FIG. 9 is schematic cross-sectional view taken along line A-A′ shown in FIG. 8. In addition, for simplification, a capacitor element is not shown in FIG. 8, but is only shown in FIG. 9. Meanwhile, the drawings are provided only to explain a structure of a semiconductor device and it should be understood that dimensions or sizes of each part shown may be different from those of an actual semiconductor device.

As shown in FIG. 9, the memory cell part is schematically constituted by MOS transistors Tr1 and capacitor elements Cap connected to the MOS transistors through a plurality of contact plugs.

In FIGS. 8 and 9, a semiconductor substrate 101 is made of silicon (Si) containing a p-type impurity at a predetermined concentration. The semiconductor substrate 101 is formed with an element isolation region 103. The element isolation region 103 is formed at a part except active regions (K) by embedding an insulating film such as a silicon oxide film (SiO₂) in a surface of the semiconductor substrate 101 by a STI (Shallow Trench Isolation) method and is insulation-isolated from a neighboring active region (K). In an exemplary embodiment, it is shown a case of a cell structure where a memory cell of 2 bits is arranged in one active region (K).

In an exemplary embodiment, as a planer structure shown in FIG. 8, a plurality of active regions (K) having a thin and long rectangular shape are aligned to be inclined in a right diagonally downward direction at a predetermined interval and arranged in accordance with a layout generally referred to as a 6F2-type memory cell. Both ends and a central part of each active region (K) are formed with an impurity diffusion layer, respectively, which function as a source/drain region of the MOS transistor (Tr1). Positions of substrate contact parts 205a, 205b and 205c are defined so that they are arranged just above the source/drain regions (impurity diffusion layers).

In FIG. 8, bit wirings 106 of a broken line shape (bent shape) extend in a horizontal (X) direction. The bit wirings 106 are arranged at an interval in the vertical (Y) direction of FIG. 8. In addition, word wirings W of a straight line shape are arranged which extends in the vertical (Y) direction of FIG. 8. Each of word wirings W is arranged at a predetermined interval in the horizontal (X) direction of FIG. 8. The word wiring W is structured to include a gate electrode 105 shown in FIG. 9 in a part at which word wiring W intersects active region K. In an exemplary embodiment, the MOS transistor Tr1 has a gate electrode of a recess shape.

As shown in the sectional structure of FIG. 9, impurity diffusion layers 108 functioning as a source/drain region are spaced and formed in the active regions K sectioned in element isolation regions 103 of semiconductor substrate 101 and gate electrodes 105 of a recess shape are formed between impurity diffusion layers 108. The gate electrode 105 is formed to protrude above an upper part of the semiconductor substrate 101 by a multi-layered film of a polycrystal silicon film and a metal film. The polycrystal silicon film may be formed by including an impurity such as phosphorous when forming a film through a CVD method. As a metal film for a gate electrode, metal having a high melting point such as tungsten (W), tungsten nitride (WN), tungsten silicide (WSi) and the like may be used.

In addition, as shown in FIG. 9, gate insulating films 105a are formed between gate electrodes 105 and the semiconductor substrate 101. In addition, sides of the gate electrode 105 are formed with side walls 105b by an insulating film such as silicon nitride (Si₃N₄). An upper surface of the gate electrode 105 is also formed with an insulating film 105c of silicon nitride, for example, so that the insulating film protects the upper surface of the gate electrode 105.

An impurity diffusion layer 108 is formed by introducing phosphorous, for example, as an N-type impurity, into the semiconductor substrate 101. Substrate contact plugs 109 are formed to contact the impurity diffusion layers 108. The substrate contact plugs 109 are respectively arranged at the positions 205c, 205a, 205b of the substrate contact parts shown in FIG. 8, and are formed with polycrystal silicon containing phosphorous, for example. A horizontal (X) width of substrate the contact plug 109 is formed into a self alignment structure shape in which the width is defined by the side walls 105b provided to the neighboring gate wirings W.

As shown in FIG. 9, an first interlayer insulating film 104 is formed to cover the insulating films 105c on the gate electrodes and the substrate contact plugs 109 and a bit line contact plug 104A is formed to penetrate the first interlayer insulating film 104. The bit line contact plug 104A is located at the position of a substrate contact part 205a and is conductively connected to a substrate contact plug 109. The bit line contact plug 104A is formed by stacking tungsten (W) and the like on a barrier film (TiN/Ti) consisting of a stacked film of titanium (Ti) and titanium nitride (TiN). The bit wiring 106 is formed to connect with the bit line contact plug 104A. The bit wiring 106 is made of a stacked film consisting of tungsten nitride (WN) and tungsten (W).

A second interlayer insulating film 107 is formed to cover the bit wiring 106. Capacitive contact plugs 107A are formed to penetrate the first interlayer insulating film 104 and the second interlayer insulating film 107 and to connect with the substrate contact plugs 109. The capacitive contact plugs 107A are arranged at the positions of substrate contact parts 205b, 205c.

A third interlayer insulating film 111 made of silicon nitride and a to fourth interlayer insulating film 112 made of silicon oxide are formed on the second interlayer insulating film 107. Capacitor elements (Cap) are formed to penetrate the third interlayer insulating film 111 and the fourth interlayer insulating film 112 and to connect with the capacitive contact plugs 107A.

The capacitor element (Cap) is configured in such a manner that a capacitive insulating film 114 is sandwiched between a lower electrode 113 and an upper electrode 115 using the method described with respect to the first exemplary embodiment. That is, it has the structure in which a TiAlO layer as an intergranular isolating layer is sandwiched between two crystallized zirconium oxide layers. A film-forming condition is controlled such that the content of the aluminum oxide component in the TiAlO layer is within a range of 5 to 10 atomic %. The lower electrode 113 is conductively connected to the capacitive contact plug 107A.

A fifth interlayer insulating film 120 made of silicon oxide or the like, an upper wiring layer 121 made of aluminum (Al), copper (Cu) or the like, and a surface protecting film 122 are formed on the fourth interlayer insulating film 112.

The upper electrode 115 of the capacitor element (Cap) is provided with a predetermined potential, so that it functions as a DRAM device performing an information storing operation by determining whether or not charges kept in the capacitor element (Cap).

In the followings, a method of forming a capacitor element (Cap) will be described in detail with reference to FIGS. 10 to 12. FIGS. 10 to 12 are partial cross-sectional views showing only upper parts from a third interlayer insulating film 111.

First, as shown in FIG. 10, a third interlayer insulating film 111 and a fourth interlayer insulating film 112 are deposited to have a predetermined film thickness. Then, an opening hole 112A for forming a capacitor element is formed with a photolithography technique such that it penetrates the third interlayer insulating film 111 and the fourth interlayer insulating film 112. After that, a lower electrode 113 is formed with dry etching or CMP (Chemical Mechanical Polishing) technique so that it remains only inner walls of opening 112A. While titanium nitride is used as a material of the lower electrode 113, another metal film may also be used.

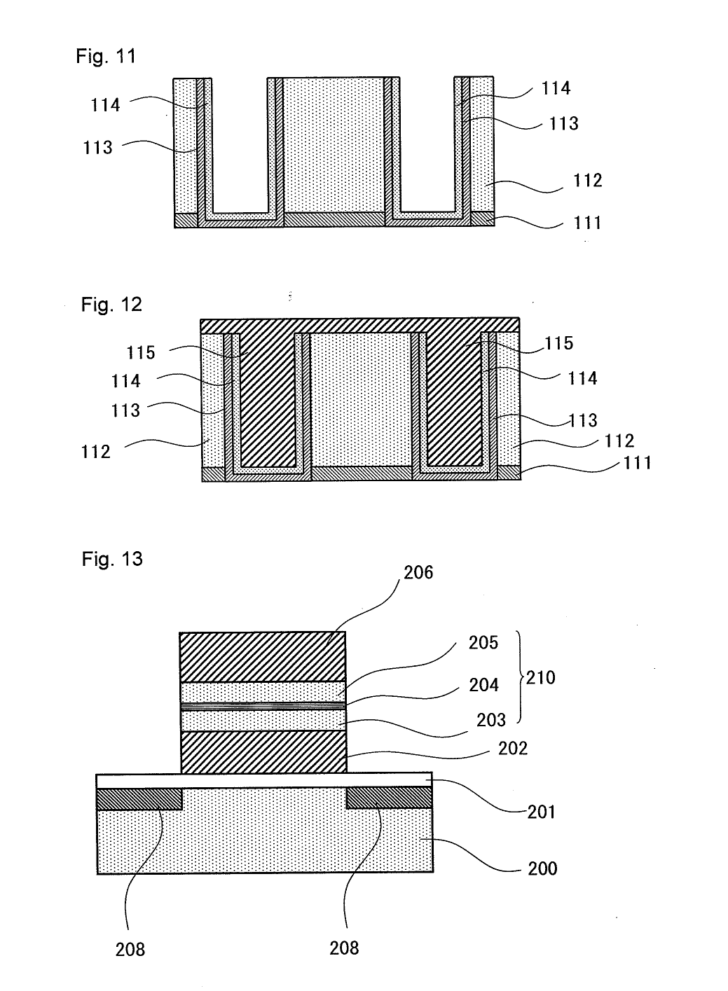

Next, as shown in FIG. 11, a zirconium oxide layer having a thickness of about 3 to 5 nm, a TiAlO film having a thickness of about 0.5 to 0.8 nm, and a zirconium oxide film having a thickness of about 3 to 5 nm are sequentially deposited using an ALD method, so that a capacitive insulating film 114 having a total of three layers. The details are described in the first embodiment.

Subsequently, as shown in FIG. 12, a titanium nitride layer is deposited to fill the inside of the opening 112A while covering the capacitive insulating film 114, thereby forming an upper electrode 115. A material for the upper electrode 115 may be the same as or different from that of the lower electrode 113. Further, each of the lower electrode 113 and the upper electrode 115 may be formed of a stacked film having a plurality of metal films. For example, when the upper electrode 115 has a stacked structure of a titanium nitride layer (as a lower layer) and a polysilicon layer (as an upper layer), the inside of the opening 112A may be easily filled with the upper electrode 115. When the zirconium oxide layer is not sufficiently crystallized in consideration of heat applied when the upper electrode 115 is formed, the zirconium oxide layer is completely crystallized by heat treatment to under nitrogen atmosphere at about 500° C.

Thereby, a capacitor element Cap is completed. The intergranular isolating layer (in the case of the above-mentioned example, a TiAlO film) is kept amorphous to the last by properly setting a composition ratio thereof and entire conditions of the heat treatment after being formed.

A capacitor element Cap may be a crown type in which inner and outer walls of the lower electrode 113 are used as an electrode, or a pillar type in which only the outer wall of the lower electrode 113 is used as an electrode by completely filling the lower electrode 113 into the opening 112A.

According to an exemplary embodiment, even when the size of the memory cell is reduced by miniaturization, it is possible to easily form a capacitor element having high capacitance and low leakage current. Thus, it is easy to form a DRAM device, which is excellent in charge retention characteristic (refresh characteristic) due to high integration.

### Third Embodiment

An insulating film of an exemplary embodiment may be used as an intergate insulating film of a nonvolatile memory device (e.g. a flash memory) or a high-K gate insulating film of a typical MOS transistor, in addition to a capacitive insulating layer of a capacitor element.

The case where an insulating film of an exemplary embodiment is applied to a nonvolatile memory device will be described with reference to FIG. 13.

A floating gate electrode 202 is formed on a semiconductor substrate 200, which is formed of P-type silicon, via an intergate insulating film 210 formed of a silicon oxide film. Thus, the intergate insulating film 210 is formed on the floating gate electrode 202 using the insulating film of an exemplary embodiment, and a control gate electrode 206 is formed on the intergate insulating film 210. The intergate insulating film 210 is formed by sandwiching a TiAlO film as an intergranular isolating layer 204 between crystallized zirconium oxide layers 203 and 205.

The semiconductor substrate 200 has an N-type impurity film 208 formed by ion implantation. The N-type impurity film 208 functions as a source or drain region. The control gate electrode 206 controls the state of electrons trapped on the lower film (gate insulating film) of the floating gate electrode 202, so that it is possible to perform the storage of information on the nonvolatile memory device.

Since an insulating film of an exemplary embodiment is used as the intergate insulating layer, it is possible to provide low leakage current and high capacitance between the floating gate electrode and the control gate electrode. Thus, it is possible to easily form a high-performance nonvolatile memory device despite miniaturization.

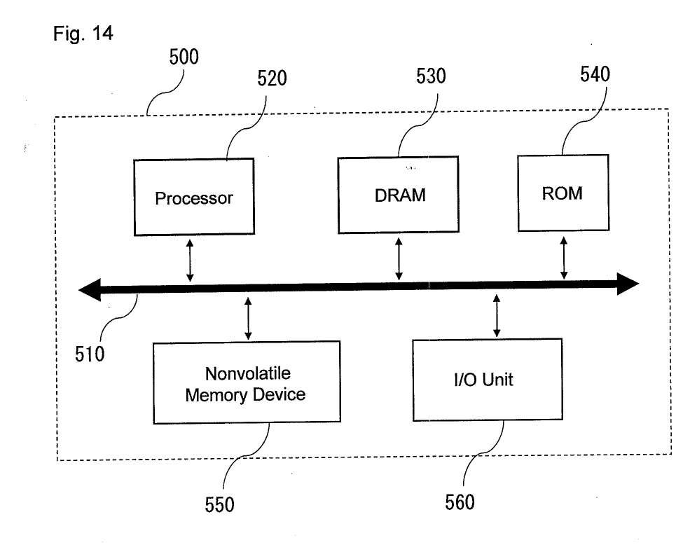

The DRAM device or the nonvolatile memory device manufactured as described above can be used to form, for instance, a data processing system, which will be described below. FIG. 14 is a schematic view showing configuration of the data processing system according to this embodiment.

A data processing system 500 includes an arithmetic processing device 520 and a DRAM device 530, which are interconnected via a system bus 510. The arithmetic processing device 520 includes a microprocessing unit (MPU) or a digital signal processor (DSP). The DRAM device 530 includes a memory cell formed by a method described in a second embodiment. Further, a ROM (read-only memory) 540 may be connected to the system bus 510 to storage invariable data.

In FIG. 14, for clarity, only one system bus 510 is shown. If necessary, the system bus 510 may be connected in series and/or parallel through a connector. Further, the devices may be interconnected by a local bus without the system bus 510.

Further, the data processing system 500 is configured so that a nonvolatile memory device 550 and an input/output unit 560 are connected to the system bus 510 as needed. The nonvolatile memory device 550 may use a hard disc, an optical drive, an SSD (solid state drive), or the like. The SSD may use a NAND-type flash memory having a memory device as described in a third embodiment. The input/output unit 560 includes, for instance, a display apparatus such as a liquid crystal display, or a data input apparatus such as a keyboard.

For clarity, each component of the data processing system 500 is shown in single in FIG. 14. However, without being limited to this configuration, there may be a plurality of all or any components. The data processing system 500 includes, for instance, a computer system, but it is not limited to this computer system.

In addition, while not specifically claimed in the claim section, the applications reserve the right to include in the claim section at any appropriate time the following semiconductor devices and data processing systems:
AA1. A semiconductor device comprising a memory cell including a capacitor element having a capacitive insulating film between an upper electrode and a lower electrode,

the capacitive insulating film comprising:

two zirconium oxide layers in crystallized state; and

an intergranular isolating layer composed of an amorphous material having a dielectric constant higher than that of zirconium oxide in crystallized state,

wherein the intergranular isolating layer is sandwiched between the two zirconium oxide layers.
AA2. The semiconductor device of the above AA1, wherein the intergranular isolating layer comprises a metal oxide containing titanium and aluminum.
AA3. The semiconductor device of the above AA1, wherein the intergranular isolating layer is a TiAlO layer.
AA4. The semiconductor device of the above AA3, wherein the content of aluminum oxide component in the intergranular isolating layer is 5 to 15 atomic %.
AA5. The semiconductor device of the above AA1, wherein the zirconium oxide is in crystallized state of a tetragonal structure.
AA6. The semiconductor device of the above AA1, wherein the intergranular isolating layer has a thickness of from 0.5 nm to 1.0 nm.
AA7. The semiconductor device of the above AA6, wherein the insulating film has an effective oxide thickness (EOT) of from 0.65 to 0.8 nm.
AA8. The semiconductor device of the above AA1, wherein the intergranular isolating layer comprises a metal oxide including at least one of Hf, La, Ta and Y.
BB1. A semiconductor device comprising a memory cell including a capacitor element having a capacitive insulating film between an upper electrode and a lower electrode,

the capacitive insulating film comprising:

three zirconium oxide layers in crystallized state; and

two intergranular isolating layers composed of an amorphous material having a dielectric constant higher than that of zirconium oxide in crystallized state,

wherein each of the intergranular isolating layers is sandwiched between two of the three zirconium oxide layers.
BB2. The semiconductor device of the above BB1, wherein each of the intergranular isolating layers is a TiAlO layer.
BB3. The semiconductor device of the above BB2, wherein the content of aluminum oxide component in each of the intergranular isolating layers is 5 to 15 atomic %.
CC1. A semiconductor device comprising a nonvolatile memory device having an intergate insulating film between a control gate electrode and a floating gate electrode,

the intergate insulating film comprising:

two zirconium oxide layers in crystallized state; and

an intergranular isolating layer composed of an amorphous material having a dielectric constant higher than that of zirconium oxide in crystallized state,

wherein the intergranular isolating layer is sandwiched between the two zirconium oxide layers.
CC2. The semiconductor device of the above CC1, wherein each of the intergranular isolating layers is a TiAlO layer.
CC3. The semiconductor device of the above CC2, wherein the content of aluminum oxide component in each of the intergranular isolating layers is 5 to 15 atomic %.
CC4. The semiconductor device of the above CC1, wherein the intergranular isolating layer has a thickness of from 0.5 nm to 1.0 nm.
DD1. A data processing system comprising an arithmetic processing device and a DRAM device, which are interconnected to the data processing system via a system bus,

the DRAM device comprising a memory cell including a capacitor element having a capacitive insulating film between an upper electrode and a lower electrode,

the capacitive insulating film comprising:

two zirconium oxide layers in crystallized state; and

an intergranular isolating layer composed of an amorphous material having a dielectric constant higher than that of zirconium oxide in crystallized state,

wherein the intergranular isolating layer is sandwiched between the two zirconium oxide layers.
DD2. The data processing system of the above DD1, wherein the intergranular isolating layer comprises a metal oxide containing titanium and aluminum.
DD3. The data processing system of the above DD1, wherein the intergranular isolating layer is a TiAlO layer.
DD4. The data processing system of the above DD3, wherein the content of aluminum oxide component in the intergranular isolating layer is 5 to 15 atomic %.
DD5. The data processing system of the above DD1, wherein the zirconium oxide is in crystallized state of a tetragonal structure.
DD6. The data processing system of the above DD1, wherein the intergranular isolating layer has a thickness of from 0.5 nm to 1.0 nm.
DD7. The data processing system of the above DD6, wherein the capacitive insulating film has an effective oxide thickness (EOT) of from 0.65 to 0.8 nm.
DD8. The data processing system of the above DD1, wherein the intergranular isolating layer comprises a metal oxide including at least one of Hf, La, Ta and Y.

What is claimed is:

1. An insulating film comprising:
two zirconium oxide layers in crystallized state; and
an intergranular isolating layer composed of an amorphous material having a dielectric constant higher than that of zirconium oxide in crystallized state;
wherein the intergranular isolating layer is sandwiched between the two zirconium oxide layers.

2. The insulating film according to claim 1, wherein the intergranular isolating layer comprises a metal oxide containing titanium and aluminum.

3. The insulating film according to claim 1, wherein the intergranular isolating layer is a TiAlO layer.

4. The insulating film according to claim 3, wherein the content of aluminum oxide component in the intergranular isolating layer is 5 to 15 atomic %.

5. The insulating film according to claim 1, wherein the zirconium oxide is in crystallized state of a tetragonal structure.

6. The insulating film according to claim 1, wherein the intergranular isolating layer has a thickness of from 0.5 nm to 1.0 nm.

7. The insulating film according to claim 6, wherein the insulating film has an effective oxide thickness (EOT) of from 0.65 to 0.8 nm.

8. The insulating film according to claim 1, wherein the intergranular isolating layer comprises a metal oxide including at least one of Hf, La, Ta and Y.

9. The insulating film according to claim 3, wherein one of the zirconium oxide layers is disposed on a conductive material.

10. An insulating film comprising:
three zirconium oxide layers in crystallized state; and
two intergranular isolating layers composed of an amorphous material having a dielectric constant higher than that of zirconium oxide in crystallized state;
wherein each of the intergranular isolating layers is sandwiched between two of the three zirconium oxide layers.

11. The insulating film according to claim 10, wherein each of the intergranular isolating layers is a TiAlO layer.

12. The insulating film according to claim 11, wherein the content of aluminum oxide component in each of the intergranular isolating layers is 5 to 15 atomic %.

13. A method of manufacturing an insulating film, comprising:
forming a first zirconium oxide layer in amorphous state;
forming an intergranular isolating layer in amorphous state on the first zirconium oxide layer;
forming a second zirconium oxide layer in amorphous state on the intergranular isolating layer; and
annealing a stack of layers including the first and the second zirconium oxide layers and the intergranular isolating layer to crystallize zirconium oxide in amorphous state in the first and second zirconium oxide layers,
wherein after the annealing has been performed, the intergranular isolating layer is in amorphous state, and the intergranular isolating layer has a dielectric constant higher than that of zirconium oxide in crystallized state in the first and the second zirconium oxide layers.

14. The method according to claim 13, wherein the intergranular isolating layer comprises a metal oxide containing titanium and aluminum.

15. The method according to claim 13, wherein the intergranular isolating layer is a TiAlO layer.

16. The method according to claim 15, wherein the content of aluminum oxide component in the intergranular isolating layer is 5 to 15 atomic %.

17. The method according to claim 13, wherein each of the zirconium oxide in the first and the second zirconium oxide layers is in a crystallized state of a tetragonal structure after the annealing has been performed.

18. The method according to claim 13, wherein the intergranular isolating layer is formed such as having a thickness of from 0.5 nm to 1.0 nm.

19. The method according to claim 18, wherein the stack of layers are formed such as having an effective oxide thickness (EOT) of from 0.65 to 0.8 nm after the annealing has been performed.
